(19) United States
(12) Patent Application Publication
(10) Pub. No.: US 2013/0227392 A1
(43) Pub. Date: Aug. 29, 2013

(54) Determining Page Elements of WebPage

(71) Applicant: Alibaba Group Holding Limited, (US)

(72) Inventors: Qi Zhong, Hangzhou (CN); Xuanmin Lin, Hangzhou (CN); Jingjing Shen, Hangzhou (CN)

(73) Assignee: Alibaba Group Holding Limited, Grand Cayman (KY)

(21) Appl. No.: 13/773,487

(22) Filed: Feb. 21, 2013

(30) Foreign Application Priority Data
Feb. 28, 2012 (CN) 201210048839.3

(51) Int. Cl. G06F 17/21

(52) U.S. Cl. CPC G06F 17/211
USPC 715/234

(57) ABSTRACT

The present disclosure provides a method and an apparatus for determining page elements of a webpage. Attributes and a number of the page elements to be presented at the webpage are determined. The number of page elements having the corresponding attributes and corresponding weighted result values satisfying a presentation requirement are selected from a page element database. The weighted result values of the page elements are determined according to the operation information operated by the users to the page elements and the page elements to be presented are selected based on the weighted result values of the page elements. The page elements of the webpage are more in compliance with the users' visiting trend, thereby reducing visiting unnecessary information and occupying less network transmission resources.

### CROSS REFERENCE TO RELATED PATENT APPLICATIONS

This application claims foreign priority to Chinese Patent Application No. 201210048839.3 filed on 28 Feb. 2012, entitled “Method and Apparatus of Determining Page Elements of Webpage,” which is hereby incorporated by reference in its entirety.

### TECHNICAL FIELD

The present disclosure relates to the field of internet technology and, more specifically, to a method and an apparatus of determining page elements of a webpage.

### BACKGROUND

With the coming of the electronic information age, the Internet plays an important role in our daily lives as people can quickly and timely obtain all kinds of information through the Internet. Internet applications become popular as they benefit our lives and works.

One important aspect of internet applications is the different kinds of information presented to users through websites. Some typical information presentation websites include different trading websites, information publication websites, etc. For example, at a trading website, sellers present information describing product attributes of products at webpages to be viewed by buyers. Electronic information corresponding to the products may be in different formats, such as pictures, text, etc.

The information presented at the webpage is generally called page elements, which may include text, picture, audio, animation, video, etc. When a user, as a publisher, publishes information, the user intends for the published information to receive attention. Particularly, for the information corresponding to products, an attention rate is directly related to a volume of sales. Thus, the information is usually published in certain ways. In other words, the page elements of the webpage are constructed in certain ways. A determination of page elements of the webpage includes a determination of the page elements to be presented at the webpage and a determination of a layout of the page elements of the webpage (i.e., locations of the page elements on the webpage). Currently, there are two methods for determining the page elements of the webpage.

A first method is to determine the page elements presented at the webpage by a webpage maintenance person.

The webpage maintenance person selects the page elements which are mostly relevant to a subject of the webpage and are mostly interesting to viewers according to the subject of the webpage. The webpage maintenance person also designs the layout of the page elements (i.e., the locations of the page elements to be arranged at the webpage) and finally determines the webpage to be presented. This procedure may be performed periodically based upon needs to periodically update the page elements of the webpage.

A second method is to determine the page elements of the webpage according to user feedback.

The page elements presented first at the webpage may be determined by the first method. In other words, the webpage maintenance personnel selects the page elements and determines the locations of the page elements to be presented at the webpage. After the webpage is presented, comment information of the page elements of the webpage reported by the webpage viewers (the users) may be obtained, and the webpage maintenance personnel may adjust the page elements according to the obtained comment information. For example, a page element receiving good feedback may be displayed at a place on the webpage that is easier to be viewed by the user, and the page element receiving poor feedback may be displayed at a place on the webpage that is not easy to be viewed by the user. The page element receiving poor feedback may even be deleted.

Generally, the frontier location the page element is placed at, the more easily that the page element is viewed by the users. Thus, the selection of the page elements and the determination of their locations are important to an optimization of the webpage. The above two methods cannot meet the requirements of network optimization due to the following reasons.

In the first method, the selection and layout of the page elements are decided by the webpage maintenance personnel. The presentation result of the webpage does not represent a visiting trend of the webpage viewers. The information that the users really need may be located at back places. Thus, the users may finally find the information that they need after reviewing all page elements located at the front places of the webpage. It is apparent that the process of accessing unnecessary information by the users occupies network transmission resources.

In the second method, although the locations of the page elements of the webpage may be adjusted based on the comments of the users, the second method requires the users to report their feedback information to the server. Such reporting process still occupies the network transmission resources.

Thus, the conventional methods for determining the page elements of the webpage unnecessarily occupy network transmission resources.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and an apparatus for determining page elements of a webpage. The present techniques may optimize the page elements of the webpage and reduce the occupation of network transmission resources.

The present disclosure provides a method for determining the page elements of the webpage. Attributes and a number of the page elements of the webpage to be presented are determined. The number of page elements having the corresponding attributes and corresponding weighted result values satisfying one or more presentation requirements are selected from a page element database. The weighted result values of the page elements are determined according to operation information of page elements conducted by one or more users that were previously presented at the webpage prior to determining the page elements of the webpage at a current time.

The present disclosure also provides an apparatus for determining the page elements of the webpage. A page element information determination unit determines attributes and a number of the page elements of the webpage to be presented. A page element determination unit selects the number of page elements having the corresponding attributes and corresponding weighted result values satisfying one or more presentation requirements from the page element database. The weighted result values of the page elements are determined according to operation information of page elements conducted by one or more users that were previously presented at the webpage prior to determining the page elements of the webpage at the current time.

At least one present technique of the present disclosure determines attributes and a number of the page elements of the webpage to be presented and selects the number of page elements having the corresponding attributes and corresponding weighted result values satisfying one or more presentation requirements from the page element database. The weighted result values of the page elements are determined according to operation information conducted by the one or more users to the page elements that were previously presented at the webpage prior to determining the page elements of the webpage at the current time. The present techniques determine the weighted result values of the page elements according to the operation information conducted by the users to the page elements that were previously presented at the webpage prior to a determination of current page elements presented at the webpage and filter the page elements according to the weighted result values corresponding to the page elements. Thus, the page elements on the webpage are more in compliance with the visiting trend of the users and the page elements presented at the webpage are optimized. The occupied network transmission resource for accessing unnecessary information by the users may be reduced. It is not necessary for the users to be involved in the process of determining page elements or report the relevant information. Consequently, the use of network transmission resource may be reduced.

Some features of the present disclosure are described in detail in the specification below. Some features of the present disclosure may become apparent from the description herein or understood through implementation of the present disclosure. The purpose and advantages of the present disclosure may be shown from the specification, claims, and drawings herein.

### BRIEF DESCRIPTION OF THE DRAWINGS

To better illustrate embodiments of the present disclosure, the following is a brief introduction of FIGs to be used in descriptions of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a diagram of an example webpage presentation in accordance with a first example embodiment of the present disclosure.

FIG. 2 illustrates a flow chart of an example method for determining page elements of a webpage in accordance with the first example embodiment of the present disclosure.

FIG. 3 illustrates a flow chart of an example method for monitoring whether to re-generate the webpage in accordance with the first example embodiment of the present disclosure.

FIG. 4 illustrates a flow chart of an example method for adjusting page elements of the webpage in accordance with the first example embodiment of the present disclosure.

FIG. 5 illustrates a flow chart of an example method for determining page elements of a webpage in accordance a second example embodiment of the present disclosure.

FIG. 6 illustrates a diagram of a first example apparatus for determining page elements of a webpage in accordance with a third example embodiment of the present disclosure.

FIG. 7 illustrates a diagram of a second example apparatus for determining page elements of a webpage in accordance with the third example embodiment of the present disclosure.

FIG. 8 illustrates a diagram of a third example apparatus for determining page elements of a webpage in accordance with the third example embodiment of the present disclosure.

FIG. 9 illustrates a diagram of a fourth example apparatus for determining page elements of a webpage in accordance with the third example embodiment of the present disclosure.

### DETAILED DESCRIPTION

The present disclosure provides a method and an apparatus for determining page elements of a webpage to optimize the page elements presented at the webpage. The present techniques are applicable to a process for determining the page elements before presenting them on the webpage, and may be implemented as a method or an apparatus. The following descriptions describe some example embodiments of the present disclosure by reference to the FIGs. It should be understood that the embodiments herein are merely presented for illustration instead of limiting the scope of the present disclosure. The embodiments and features in each embodiment of the present disclosure may be combined when there is no conflict.

A first example embodiment of the present disclosure provides a method for determining the page elements of the webpage. The method may be applied at a webpage server. The method may be applicable in determining the page elements of the webpage before presenting the webpage.

In the first example embodiment, a page element database is pre-established. The page element database stores the page elements corresponding to different attributes. Before presenting the webpage, the page elements satisfying one or more presentation requirements are selected from the page elements saved in the page element database according to the presentation requirements. For example, the webpage presentation requirements may include a number of the page elements to be presented at the webpage and attributes of the page elements to be presented at the webpage. In some applications, in order to improve the presentation effects, the page elements corresponding to different attributes may be presented at different areas of the webpage, and the attributes of page elements in different areas are defined. Generally, the page elements corresponding to the same attributes may further have different attribute values. Thus, the area presenting page elements of the same attributes at the webpage may be further divided. The area may be further divided into different sub-areas according to the corresponding different attribute values of the attribute. Each sub-area presents the page elements with corresponding different attribute values of the attribute.

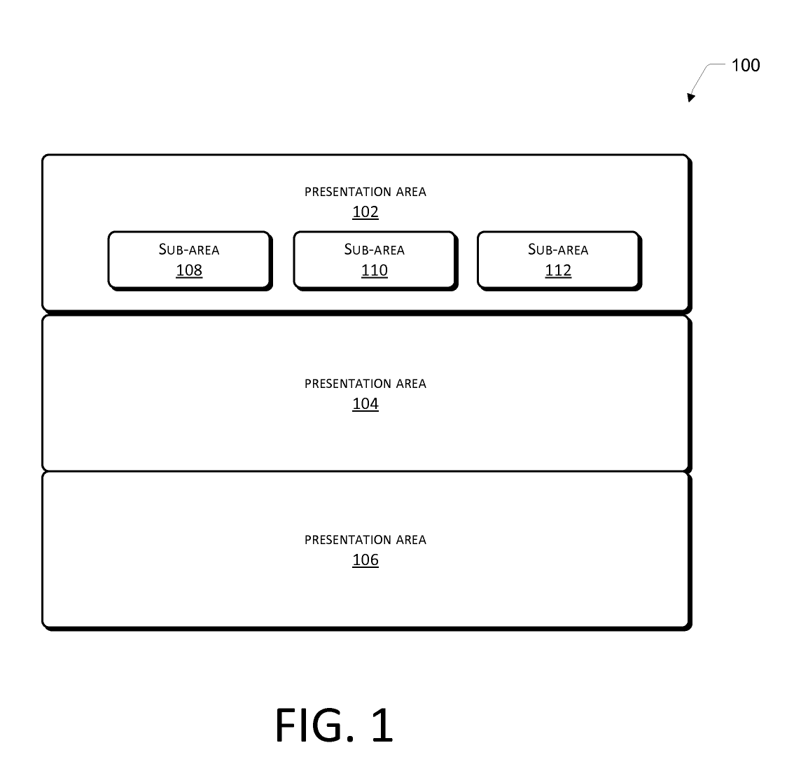

To better understand the division of the webpage presentation areas, FIG. 1 illustrates a diagram of an example webpage presentation. As shown in FIG. 1, a webpage 100 is divided into 3 presentation areas, i.e., a presentation area 102, a presentation area 104, and a presentation area 106. The presentation areas 102, 104, and 106 are used to represent page elements with attributes A, B, and C respectively. Each presentation area 102, 104, 106, such as the presentation area 102, may present multiple page elements. For example, the attribute A may correspond to 3 attribute values A1, A2, and A3. The presentation area 102 is further divided into 3 sub-areas, i.e., a sub-area 108, a sub-area 110, and a sub-area 112. The sub-areas 108, 110, and 112 are used to present page elements with attribute values A1, A2, and A3 respectively. The diagram of presentation areas of the webpage as shown in FIG. 1 is for illustration purpose only. In applications, the division of the presentation areas of the webpage and the display configuration of the webpage may be flexibly set, which are not detailed herein.

In the first example embodiment, the page elements saved in the page element database may be dynamically updated with updates of network resources, and maintain weighted values, or weighted result values, according to presentations of the saved page elements with different attributes. For example, the weighted result values corresponding to the page elements may be determined according to the operation information conducted by users to the page elements when the page elements are presented at a webpage. In other words, the weighted result values corresponding to the page elements may be dynamically updated by the operations of the users to the page elements after they are presented. The process of determining the weighted result values corresponding to the page elements will be described below in more details. In applications, the page elements stored in the page element database may be classified and stored according to their corresponding attributes.

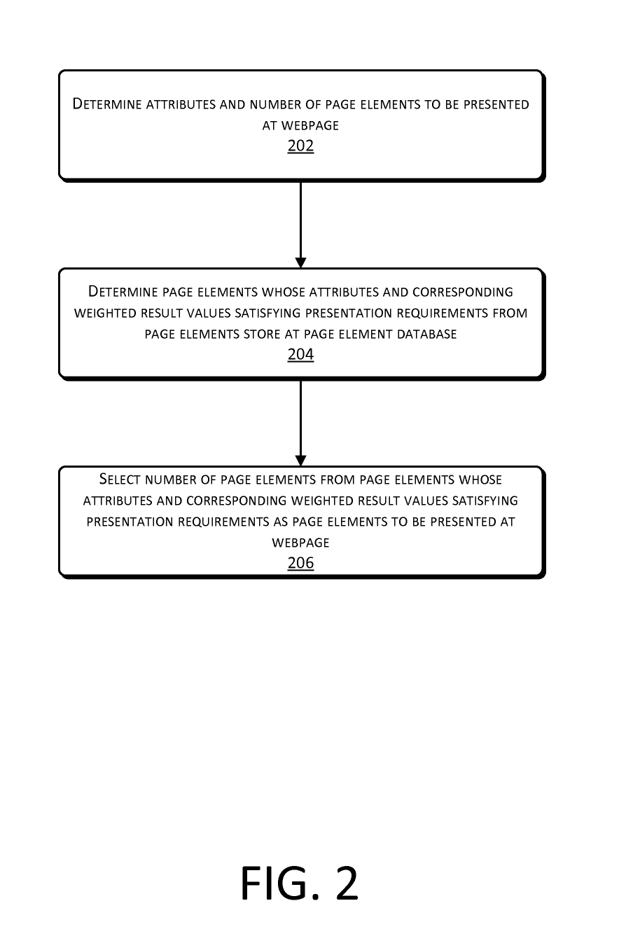

FIG. 2 illustrates a flow chart of an example process for determining the page elements of the webpage in accordance with the first example embodiment of the present disclosure.

At 202, the attributes and a number of page elements to be presented at a webpage are determined.

The attributes and the number of page elements to be presented at the webpage may be determined according to the actual presentation requirements of the webpage. For example, when the attributes and the number of the page elements to be presented at the webpage are determined, the corresponding page elements with different attributes may be selectively determined. When the locations of the page elements with different attributes at the webpage are determined, the page elements are inserted into the corresponding locations of the webpage according to the locations of the page elements with different attributes at the following process to generate the webpage. When the locations of the page elements with different attributes at the webpage are not determined, the page elements may be randomly inserted into the webpage at the following process to generate the webpage.

At 204, the page elements that have the determined attributes and corresponding weighted result values satisfying the presentation requirements are determined from the page elements stored at the page element database.

The weighted result values of the page elements are determined according to the operation information conducted by the users to the page elements previously presented at one or more webpages before the page elements at the present webpage are determined at the current time. The presentation requirements may be flexibly set. For example, the presentation requirements may be set according to the specific method for determining the weighted result values. Generally, the page elements with the weighted result values satisfying the presentation requirements are better than the other page elements in presentation. For example, if the weighted result value is determined based on a number of times that the page elements are clicked by the users, the presentation requirement may be set that the weighted result value, which is determined by the number of times clicked by the user, is higher than a preset threshold value. The preset threshold value may be flexibly adjusted according to the actual implementations.

At 206, from the page elements that have the determined attributes and corresponding weighted result values satisfying the presentation requirements, the determined number of page elements is further selected to be presented at the webpage.

The process for determining the page elements of the webpage may end here. Based on the process as shown in FIG. 2, the present techniques determine the weighted result values of the page elements according to the operation information conducted by the users to the page elements that were previously presented at the webpage prior to the determination of current page elements presented at the webpage, and filter the page elements according to the weighted result values corresponding to the page elements. Thus, the page elements at the webpage are more in compliance with the visiting trend of the users and the page elements presented at the webpage are optimized. The occupied network transmission resource for accessing unnecessary information by the users may be reduced. It is not necessary for the users to be involved in the process of determining page elements or report the relevant information. Consequently, the use of network transmission resources may be reduced.

After the page elements are selected to be presented at the webpage through the process as shown in FIG. 2, the webpage may be further generated. For example, the selected page elements are embedded into the corresponding locations of the webpage according to the location information of the corresponding page elements with different attributes. If the location information of the corresponding page elements with different attributes at the webpage is not determined in advance, the selected page elements may be randomly embedded into the webpage.

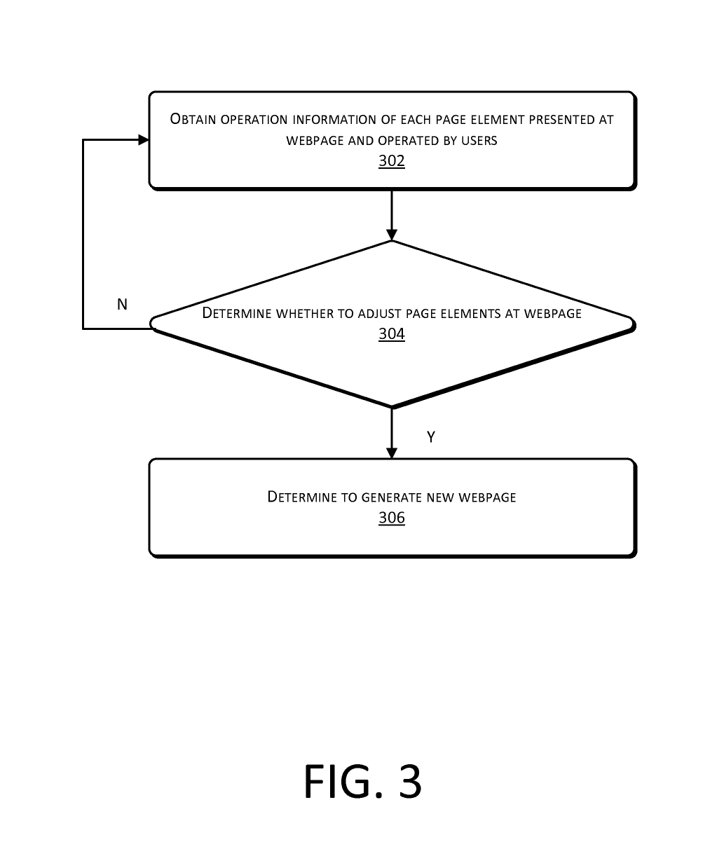

For another example, after the webpage is generated, the users' attention to the currently generated webpage may be monitored so that a new webpage may be generated when the users' attention declines. The operation information of the page elements conducted by the users may represent the users' attention to the webpage. FIG. 3 illustrates a flowchart of an example method for monitoring and determining whether to generate a new webpage.

At 302, operation information of each of the page elements, which is presented at the webpage, operated by the users is obtained.

For example, types of operations to the page elements may be pre-set. When a user operation with a preset type of operation is monitored, the operation information may be obtained.

At 304, it is determined whether to adjust the page elements of the webpage according to the operation information of the page elements operated by users. If a result of the determination is positive, operations at 306 are performed; otherwise, the process returns to 302.

In one example, at 304, after a time period to obtain the operation information at 304 reaches a preset time threshold, it is determined whether to adjust the page elements of the webpage according to the operation information of the page elements operated by users.

At 306, it is determined whether to generate a new webpage.

For example, at 306, after it is determined that the new webpage needs to be generated, page elements to be presented at the new webpage are firstly determined. The process for determining the page elements to be presented at the webpage is illustrated, by example, in the process as shown in the flowchart of FIG. 2. Thus, operations at 306 are not detailed herein.

The process for monitoring whether to generate the new webpage may end here.

For example, at 302, the operation information of the page elements operated by users may include one or more of the following types: a number of times the page elements are clicked by the users; a number of times an object described by the page elements is retrieved by the users; and a number of times the object described by the page elements is collected by users.

It should be understood that the types of operation information of the page elements operated by users listed above are only exemplary. In applications, there may be different other types of information, which are not illustrated herein.

For example, at 304, there may be multiple methods to determine whether to adjust the page elements of the webpage according to the operation information of the page elements operated by users. For example, it is determined whether to adjust the page elements of the webpage with reference to confidence degrees of the weighted result values or according to one or more pre-set conditions. These two example methods are described in detail below.

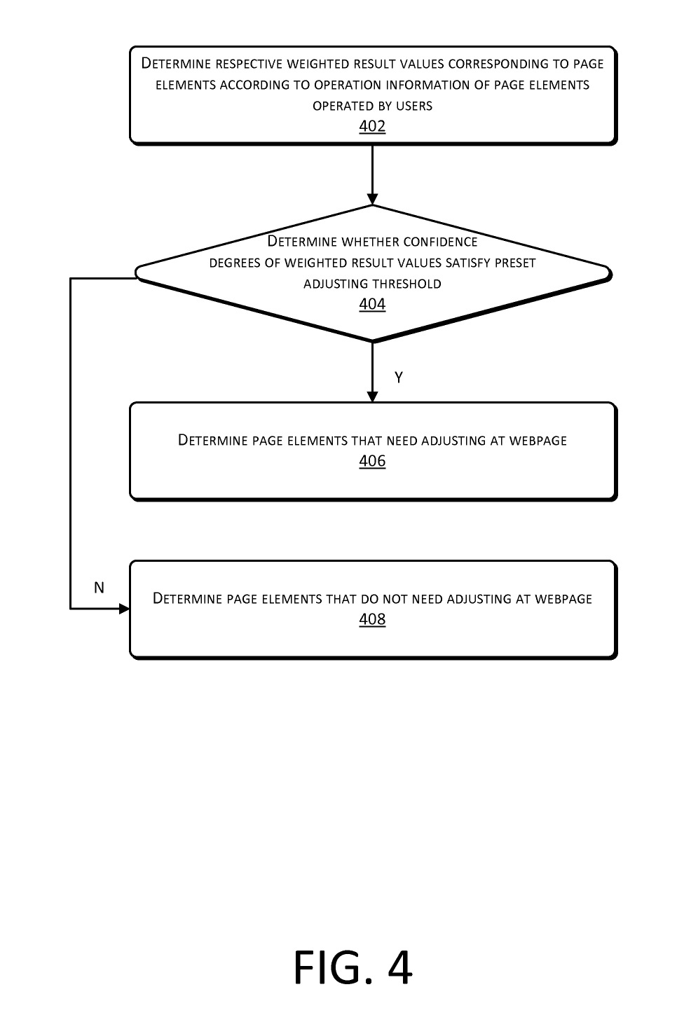

In a first example method, it is determined whether to adjust the page elements of the webpage with reference to a confidence degree of a weighted result value of each page element. A respective confidence degree of weighted result value of a respective page element may be determined based on a respective weighted result value of the respective page element and a number of times that the respective page element is presented at the webpage. For instance, the respective confidence degree may be a ratio of the respective weighted result value to the number of times that the respective page element is presented at the webpage. Generally, with the same weighted result value, the greater the number of times is, the smaller the corresponding confidence degree is. FIG.4 illustrates a flowchart of an example method for determining whether to adjust the page elements of the webpage according to the operation information of the page elements operated by users.

At 402, the weighted result values corresponding to the page elements are determined respectively according to the operation information of the page elements operated by users.

For example, at 402, the respective weighted result value of the respective page element may be determined by types of the operation information that is operated by users to the respective page element and weighted result values corresponding each of the types of the operation information. For instance, the types of the operation information of the page elements operated by users may include the number of click times and the number of collection times. The weighted result value of the types of operations information, i.e., the number of click times and the number of collection times, are A and B, respectively. The weighted result value of the respective page element is equal to the number of clicked times*A+the number of collected times*B. It should be understood that the equation described above is just an example method for calculating weighted result values. Different determination methods may be applied in real applications.

At 404, it is determined whether the confidence degrees of the weighted result values of the page elements satisfy a preset adjusting threshold respectively. If a result of the determination is positive, operations at 406 are performed; otherwise, operations at 408 are performed.

For example, at 404, the respective confidence degree may be a ratio of the respective weight result of the respective page element to the respective number of times that the respective page element is presented at the webpage. The respective number of times that the respective page element is presented at the webpage may be set as a number of presentation times that the respective page element is presented in a period of time. The adjusting threshold may be set with reference to requirements to the webpage and the specific method that determines the respective weighted result value. For example, if the weighted result value is determined according to the number of times that the users click the page elements, the adjusting threshold may be set as a preset value. The preset value may be determined based on an average click time according to the requirements to the webpage. The specific determination methods may be set according to the different application conditions, which are not detailed herein.

At 406, the page elements that need to be adjusted are determined.

At 408, the page elements that do not need to be adjusted are determined For example, the process for determining whether to adjust the page elements of the webpage may end here.

In the second example method, one or more conditions for adjusting the page elements of the webpage may be preset. The present techniques determine whether to adjust the page elements of the webpage by determining whether the operation information of the page elements operated by the users meets the conditions. The conditions for adjusting the page elements of the webpage may be determined according to the types of operation information of the page elements operated by the users. For example, if the type of operation information of the page elements operated by the users is the number of times that the users click the page elements, the condition for adjusting page elements of the webpage may be set as an average click rate of the page elements of the webpage being lower than a pre-set threshold. For another example, if the operation information of the page elements operated by the users has multiple types, different conditions for adjusting the page elements of the webpage may be set for different types of operation information. The present techniques determine whether to adjust the page elements of the webpage when the conditions of all types of operation information are met. Alternatively, a weight may be set for each type of operation information. A comprehensive value may be calculated based on a weighted method according to the weight of each type of operation information of the page element operated by the user. The present techniques then determine whether the calculated comprehensive value meets the conditions for adjusting the page elements of the webpage, such as a comparison between the calculated comprehensive value and a preset value threshold.

It should be understood that the above first and second example methods for determining whether to adjust the page elements of the webpage according to the operation information of the page elements operated by users are merely exemplary. In applications, the method for determining whether to adjust the page elements of the webpage may be flexibly set in different ways based on the actual needs, which are not detailed herein.

In some examples, when determining whether to adjust the page elements of the webpage according to the operation information of the page elements, the weighted result values cannot be determined After it is determined that there is a need to adjust the page elements of the webpage according to the operation information of page elements operated by the users and before the page elements of the webpage to be adjusted are determined, the weighted result value corresponding to each page element is determined according to the operation information of the page elements operated by the users. The determined weighted result values are used to update the weighted result values of the corresponding page elements saved in the page element database. In some examples, when determining whether to adjust the page elements of the webpage according to the operation information of page elements operated by the users, the weighted result values can be determined. There is no need to re-determine the weighted result values of the page elements. The determined weighted result value may be used to update the weighted result values of the corresponding page elements saved in the page element database.

A second example embodiment of the present disclosure provides another method for determining page elements of a webpage. Different from the methods for determining page elements of the webpage in the first example embodiment, the second example embodiment categorizes the page elements saved in the page element database into two major sets:

One set of page elements is a set of page elements whose confidence degrees of the weighted result values meet presentation requirements (referred to as “a first page element set”).

Another set of page elements is a set of page elements whose confidence degrees of the weighted result values do not meet presentation requirements and/or a set of page elements that have no corresponding weighted result values (referred to as “ a second page element set”).

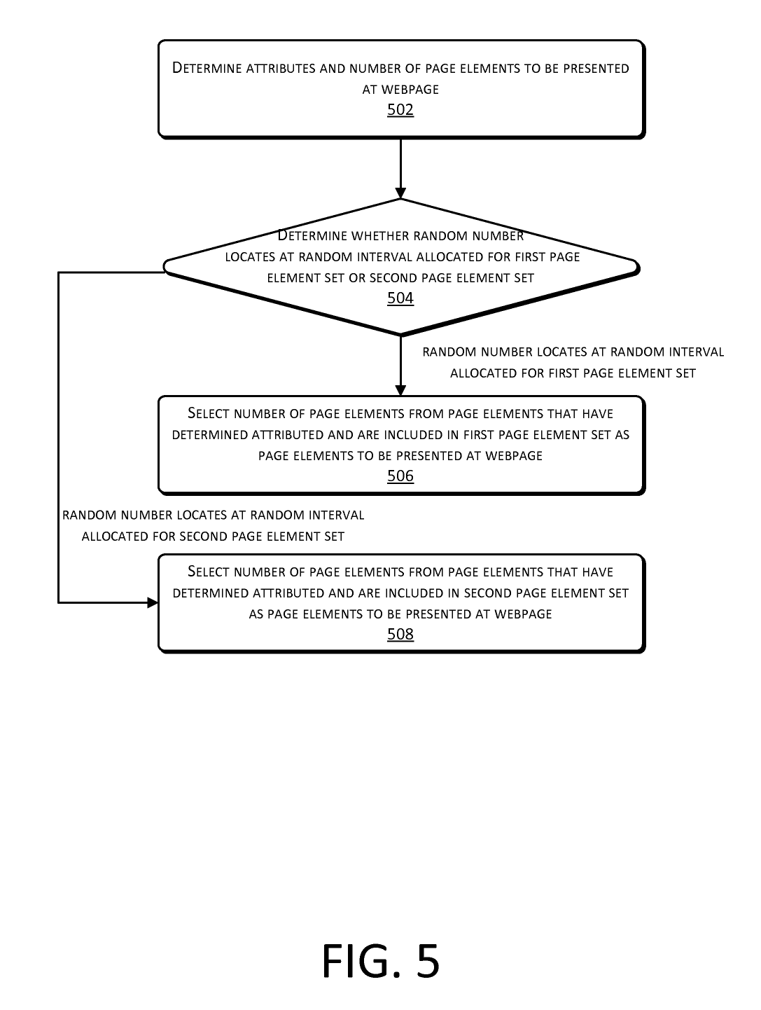

Based on the above two sets of page elements, the second embodiment of the present disclosure provides the method for determining the page elements of the webpage as shown in FIG. 5 including the following major processes.

At 502, the attributes and number of page elements of the webpage to be presented are determined.

The operations at 502 are the same as or similar to those at 202 and thus the detailed operations at 502 are not detailed herein.

At 504, a random number is generated and a random interval that the random number locates is determined If the random number is within a random interval allocated for the first page element set, operations at 506 are performed. If the random number is within a random interval allocated for the second page element set, operations at 508 are performed.

At 504, as the first page element set is the set of page elements whose confidence degrees of the weighted result values meet the presentation requirements, a presentation probability of the first page element set needs to be increased. That is, the random interval allocated for the first page element set is directly proportional to the number of page elements included in the first page element set. In other words, the greater the number of page elements contained in the first page element set is, the larger the random interval allocated for the first page element set will be. Thus, the probability that the generated random number is in the random interval allocated for the first page element set is also greater.

On the contrary, as the second page element set is the set of page elements whose confidence degrees of the corresponding weighted result values do not the meet presentation requirements and/or the set of page elements having no corresponding weighted result values. Based on ensuring that the page elements in the second page element set may have an opportunity for presentation, a presentation probability of the second page element set needs to be decreased. That is, the random interval allocated for the second page element set is inversely proportional to the number of page elements included in the second page element set. In other words, the greater the number of page elements contained in the second page element set is, the smaller the random interval allocated for the second page element set will be. Thus, the probability that the generated random number is in the random interval allocated for the second page element set is also smaller.

At 506, page elements corresponding to the number of page elements which need to be presented in the webpage are selected from the page elements that have the determined attributes of the page elements and are saved in the first page element set, as the page elements of the webpage to be presented.

For example, at 506, based on the weighted result values corresponding to the page elements having the corresponding attributes and saved in the first page element set, the number of page elements are selected from the page elements having the corresponding attributes and saved in the first page element set according to their corresponding weighted result values in a descending order as the page elements of the webpage to be presented.

At 508, page elements corresponding to the number of page elements which need to be presented in the webpage are selected from the page elements that have the determined attributes and are saved in the second page element set as the page elements of the webpage to be presented.

For example at 508, based on the number of presentation times of the page elements that have the corresponding attributes and are saved in the second page element set, the page elements that have the corresponding attributes and are saved in the second page element set are ranked according to their presentation times in a descending order. The determined number of page elements is selected from such ranked page elements as the page elements of the webpage to be presented.

The process for determining page elements of a webpage in FIG. 5 may end here.

The methods for determining the page elements of the webpage as illustrated in the second example embodiment may take into account the page elements that are newly updated, not presented, or have poor presentation effects to properly present such kinds of page elements, thereby ensuring a balance among the page elements presented on a webpage can be guaranteed.

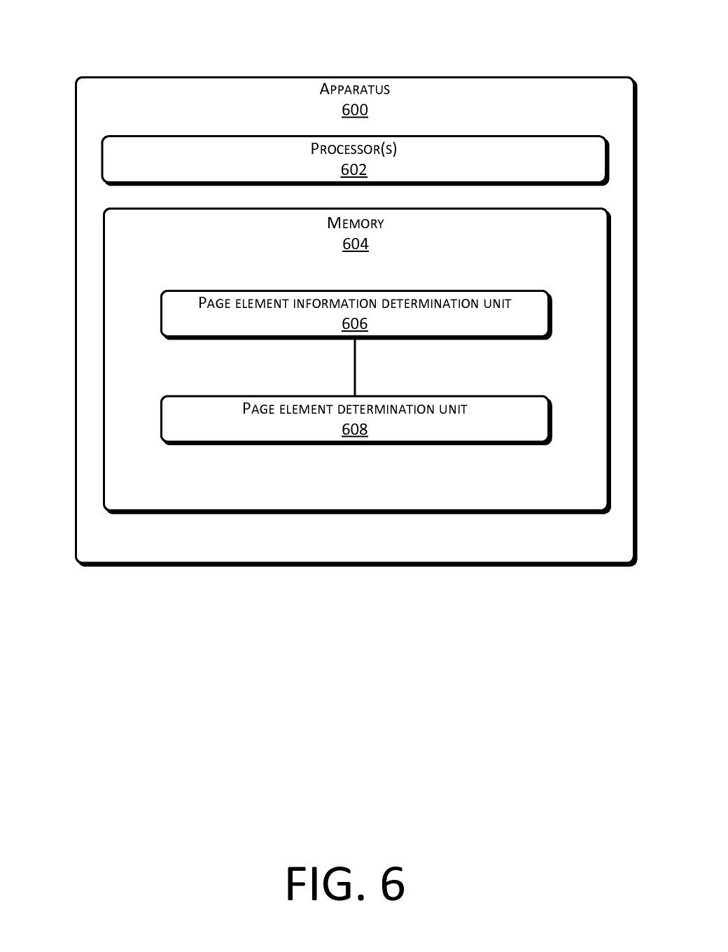

Corresponding to the methods for determining the page elements of the webpage as illustrated in the first example embodiment and the second example embodiment, a third example embodiment of the present disclosure provides an apparatus for determining page elements of a webpage as shown in FIG. 6. An apparatus 600 in FIG. 6 may include one or more processor(s) 602 and memory 604. The memory 604 is an example of computer-readable media. As used herein, “computer-readable media” includes computer storage media and communication media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage apparatus, or any other non-transmission medium that can be used to store information for access by a computing apparatus. In contrast, communication media may embody computer-readable instructions, data structures, program modules, or other data in a modulated data signal, such as a carrier wave. As defined herein, computer storage media does not include communication media.

The memory 604 may store therein program units or modules and program data. In the example of FIG. 6, the memory 604 may store therein a page element information determination unit 606 and a page element determination unit 608.

The page element information determination unit 606 determines attributes and a number of page elements to be presented at the webpage.

The page element determination unit 608 selects the determined number of page elements as the page elements of the webpage to be presented from page elements that have the corresponding attributes determined by the page element information determination unit 606 and corresponding weighted result values satisfying presentation requirements and are stored in a page element database. The weighted result values of the page elements are determined according to the operation information operated by the users when the page elements are presented previously on the webpage prior to a determination of the page elements of the webpage at a current time.

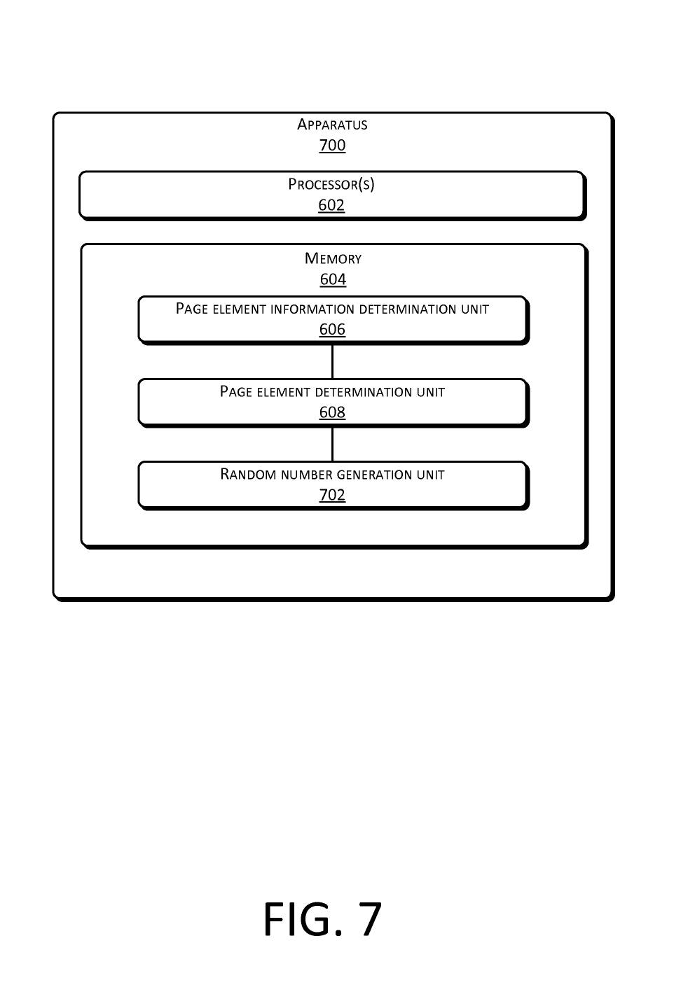

FIG. 7 illustrates another example apparatus 700 in accordance with another implementation of the third example embodiment of the present disclosure. The apparatus 700 as shown in FIG. 7, based on the apparatus 600 as shown in FIG. 6, may further include a random number generation unit 702.

The random number generation unit 702 generates a random number and determines a random interval in which the random number locates.

Correspondingly, the page element determination unit 608, when the random number generated by the random number generation unit 702 is within the random interval allocated for the first page element set, selects the determined number of page elements as the page elements to be presented at the webpage from the page elements that have the corresponding attributes and are saved in the first page element set. The first page element set is a set of page elements whose confidence degrees of the corresponding weighted result values meet the presentation requirements. For instance, the confidence degree of the weighted result value of a respective page element may be determined according to the weighted result value of the respective page elements and the number of times that the respective page element is presented at the webpage.

In an example, the page element determination unit 608 may, based on the weighted result values corresponding to the page elements that have the corresponding attributes and that are saved in the first page element set, select the determined number of page elements as the page elements to be presented at the webpage from the page elements that have the corresponding attributes and that are saved in the first page element set according to their corresponding weighted result values in a descending order.

When the random number generated by the random number generation unit 702 is within the random interval allocated for the second page element set, the page element determination unit 608 may select the number of page elements from the page elements that have the corresponding attributes and that are saved in the second page element set as the page elements of the webpage to be presented. The second page element set is a set of page elements whose confidence degrees of corresponding weighted result values do not meet presentation requirements, and/or a set of page elements having no corresponding weighted result values.

For example, the page element determination unit 608 may, based on the number of presentation times corresponding to the page elements that have the corresponding attributes and that are saved in the second page element set, select the determined number of page elements as the page elements to be presented at the webpage from the page elements that have the corresponding attributes and that are saved in the second page element set according to their presentation times in a descending order.

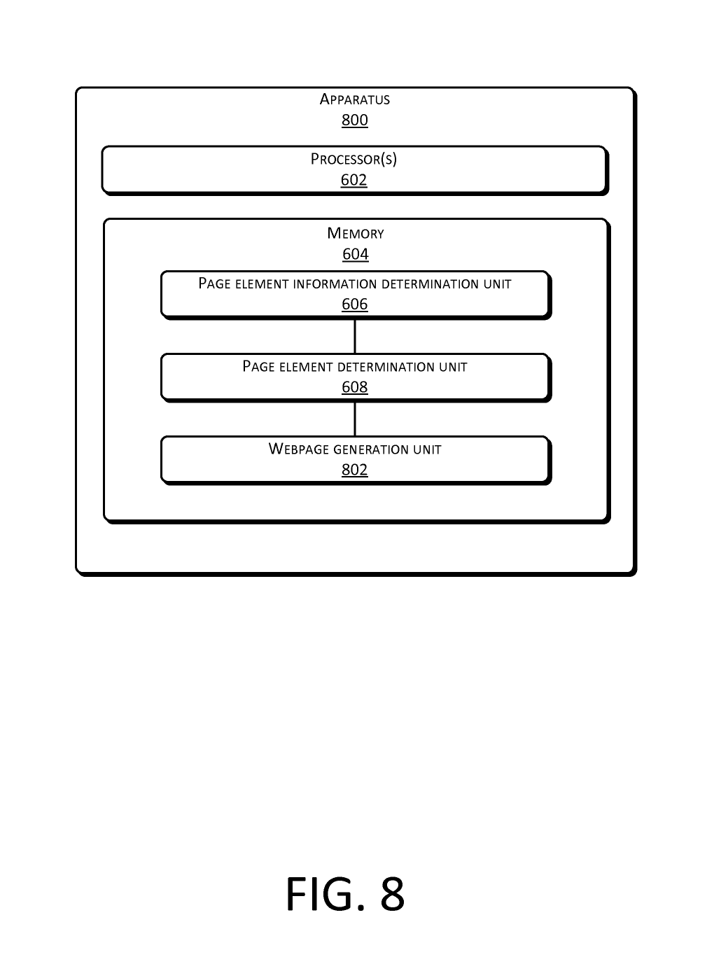

FIG. 8 illustrates another example apparatus 800 in accordance with another implementation of the third example embodiment of the present disclosure. The apparatus 800 as shown in FIG. 8, based on the apparatus 600 as shown in FIG. 6, may further include a webpage generation unit 802.

The webpage generation unit 802, after the page element determination unit 608 selects the number of page elements as the page elements of the webpage to be presented, embeds the selected page elements with different attributes into their corresponding locations of the webpage according to location information of corresponding attributes of the page elements at the webpage.

The webpage generation unit 802 may also be included in the apparatus 700 shown in FIG. 7 to implement the same functionality.

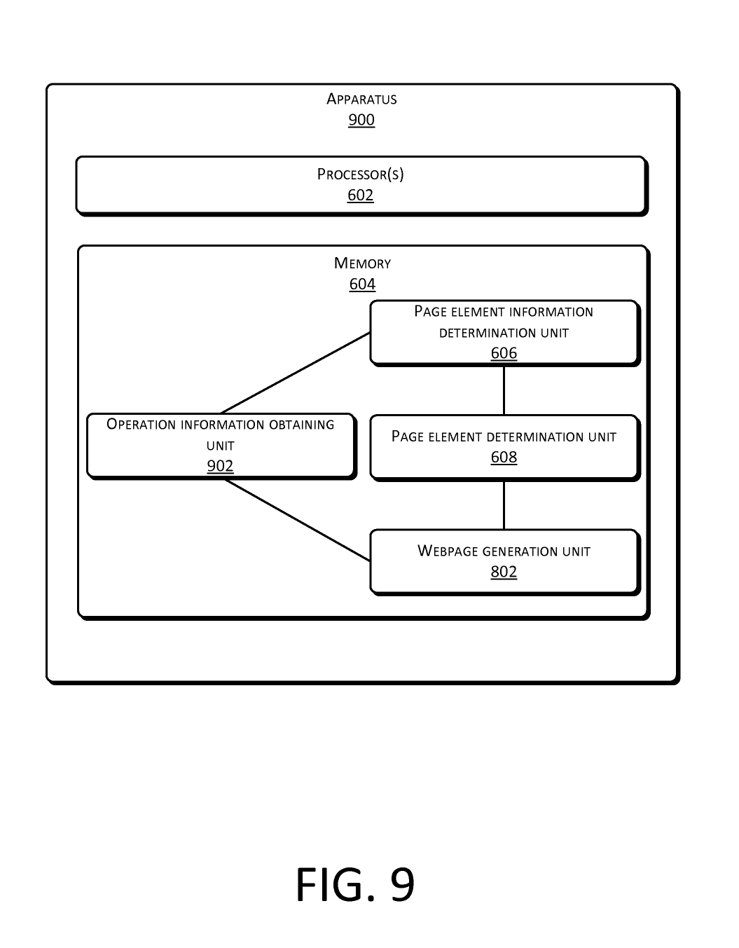

FIG. 9 illustrates another example apparatus 900 in accordance with another implementation of the third example embodiment of the present disclosure. The apparatus 900 as shown in FIG. 9, based on the apparatus 800 as shown in FIG. 8, may further include an operation information obtaining unit 902.

The operation information obtaining unit 902, after the webpage generation unit 802 generates the webpage, obtains operation information of the page elements, which are presented at the webpage, operated by users.

Correspondingly, the page element information determination unit 606, after determining page elements at the webpage that need to be adjusted according to the operation information of the page elements that are obtained by the operation information obtaining unit 902, determines the attributes and the number of the page elements to be presented at the webpage.

In an example implementation of the third example embodiment of the present disclosure, the apparatus 900 may include the page element information determination unit 606. The page element information determination unit 606, after determining that a period of time that the operation information obtaining unit 902 obtains the operation information reaches a preset time period threshold, adjusts the page elements at the webpage according to the operation information of the page elements operated by the users.

In an example implementation of the third example embodiment of the present disclosure, the apparatus 900 may also include the page element information determination unit 606. The page element information determination unit 606 determines the corresponding weighted result values of the page elements according to the operation information of the page elements operated by the users. The weighted result values corresponding to the page elements are determined based on the types of operation information included in the operation information of the page elements operated by the users and weighted values corresponding to the types of operation information. The page element information determination unit 606 may further adjust the page elements of the webpage when the confidence degrees of the weighted result values corresponding to the page elements satisfy a preset satisfaction threshold.

It should be understood that the units in the above apparatuses for determining page elements of the webpage are logically divided according to the functions they performed. In some applications, these units may be further separated or combined together. In addition, the functionalities performed by the apparatus for determining the page elements of the webpage in the third example embodiment of the present disclosure may correspond to the processes in the methods for determining the page elements of the webpage in the first example embodiment and the second example embodiment of the present disclosure. The more detailed processing implemented by the apparatuses are the same as or similar to the processing as illustrated in the method example embodiments. Thus, the more detailed processing implemented by the apparatuses are not detailed herein.

In addition, the apparatuses for determining the page elements of the webpage illustrated in the third example embodiment may also include other units that implement some other functionality as described in the first example embodiment and the second example embodiment. Thus, the other units are not detailed herein.

The apparatus for determining the page elements of the webpage may be implemented through computer-executable instruction executable by one or more processors and stored on one or more computer storage media. Person in the technical field would understand that the above classifications of the units are just some examples in various classifications of the units. If the units are not classified or classified otherwise, as long as the apparatuses for determining the page elements of the webpage is capable of implementing the above functionalities, such apparatuses are still within the protection scope of the present disclosure.

Person in the technical field may understand that the embodiments of the present disclosure may be in the form of methods, apparatuses (devices or systems), or the programming products of computers. Therefore, the present disclosure may be implemented by hardware, software, or in combination of both. In addition, the present disclosure may be in the form of one or more computer program products containing the computer-executable instructions executable by one or more processors and implemented in the computer storage medium (including but not limited to disks, CD-ROM, optical disks, etc.).

The present disclosure is described by referring to the flow charts and/or block diagrams of the method, apparatus (devices or systems) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a apparatus of implementing one or more flows of the flow chart and/or one or more blocks of the block diagram can be generated through the instructions operated by a computer or other programmable data processors.

These computer program instructions may also be saved in other computer storage media which can instruct a computer or other programmable data processors to operate in a certain way, so that the instructions saved in the computer storage generate a product containing one or more instruction apparatuses. The instruction apparatuses implement the functionalities specified in one or more flows of the flow chart and/or one or more blocks of the block diagram.

These computer program instructions may also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The example embodiments as described in the present disclosure are merely for illustrating the present disclosure and are not intended to limit the scope of the present disclosure. Person in the technical field may make additional changes or modifications to the example embodiments when they know the creative concepts in the present disclosure. Thus, the claims shall be interpreted to include not only

The example embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

What is claimed is:

1. A method for determining page elements of a webpage, comprising:
determining attributes of and a number of page elements to be presented at the webpage;
determining operation information conducted by one or more users to multiple page elements; and
selecting the number of page elements based on the determined attributes and their corresponding operation information from the multiple page elements to be presented at the webpage.

2. A method as recited in claim 1, wherein the multiple page elements are stored at a page element database.

3. A method as recited in claim 1, further comprising:
determining location information of the number of page elements based on corresponding attributes of the number of page elements; and
inserting the number of page elements at the webpage according to their location information.

4. A method as recited in claim 1, further comprising randomly inserting the number of page elements at the webpage.

5. A method as recited in claim 1, further comprising:
monitoring operation information of the number of page elements at the webpage; and
determining whether to adjust one or more page elements in the number of page elements based on the monitored operation information.

6. A method as recited in claim 5, wherein the monitoring comprises:
setting one or more types of operation conducted by the one or more users to the number of page elements; and
obtaining operation information that has the set one or more types of operation.

7. A method as recited in claim 6, wherein the one or more types of operation including one or more of following types:
a number of times a respective page element is clicked by the one or more users;
a number of times an object described by the respective page element is retrieved by the one or more users; and
a number of times the object described by the respective page elements is collected by the one or more users.

8. A method as recited in claim 5, further comprising prior to the determining whether to adjust one or more page elements in the number of page elements, determining that a period of time of the monitoring the operation information of the number of page elements satisfies a preset time threshold.

9. A method as recited in claim 5, wherein the determining whether to adjust the one or more page elements in the number of page elements comprises:
determining a respective weighted result value of a respective page element in the number of page elements;
determining whether a respective confidence degree of the respective weighted result value of the respective page element satisfies a preset adjusting threshold;
if the respective confidence degree of the respective weighted result value of the respective page element satisfies a preset adjusting threshold, determining that the respective page element is to be adjusted; and
if the respective confidence degree of the respective weighted result value of the respective page element does not satisfy the preset adjusting threshold, determining that the respective page element is not to be adjusted.

10. A method as recited in claim 9, wherein the determining the respective weighted result value of the respective page element in the number of page elements comprises:
determining the respective weighted result value of the respective page element based on one or more types of operation information to the respective page element and respective weighted values of the one or more types of operation information.

11. A method as recited in claim 9, wherein the respective confidence degree is a ratio of the respective weighted result value of the respective page element to a number of times that the respective page element is presented at the webpage.

12. A method as recited in claim 5, wherein the determining whether to adjust the one or more page elements in the number of page elements comprises:
determining a condition to adjust a respective page element;
determining whether the respective page element satisfies the condition;
if the respective page element satisfies the condition, determining that the respective page element is to be adjusted; and
if the respective page element does not satisfy the condition, determining that the respective page element is not to be adjusted.

13. A method as recited in claim 1, further comprising:
prior to the determining operation information conducted by the one or more users to the multiple page elements, classifying the multiple page elements into a first page element set and a second page element set, the first page element set including a first one or more elements whose confidence degrees of weighted result values meet a presentation requirement, the second page element set including a second one or more elements whose confidence degrees of weighted result values do not meet a presentation requirement or that have no corresponding weighted result values; and
determining that the random number is within a random number interval allocated for the first page element set, wherein:
the selecting the number of page elements based on the determined attributes and their corresponding operation information from the multiple page elements to be presented at the webpage comprises selecting the number of page elements with the determined attributes from the first page element set.

14. A method as recited in claim 1, further comprising:
prior to the determining operation information conducted by the one or more users to the multiple page elements, classifying the multiple page elements into a first page element set and a second page element set, the first page element set including a first one or more elements whose confidence degrees of weighted result values meet a presentation requirement, the second page element set including a second one or more elements whose confidence degrees of weighted result values do not meet a presentation requirement or that have no corresponding weighted result values; and
determining that the random number is within a random number interval allocated for the second page element set, wherein:
the selecting the number of page elements based on the determined attributes and their corresponding operation information from the multiple page elements to be presented at the webpage comprises selecting the number of page elements with the determined attributes from the second page element set.

15. A method for determining page elements of a webpage, comprising:
classifying multiple page elements stored at a page element database into a first page element set and a second page element set, the first page element set including a first one or more elements whose confidence degrees of weighted result values meet a presentation requirement, the second page element set including a second one or more elements whose confidence degrees of weighted result values do not meet a presentation requirement or that have no corresponding weighted result values;
determining attributes of and a number of page elements to be presented at the webpage;
generating a random number;
allocating a random number interval allocated for the first page element set and a random number interval allocated for the second page element set; and
determining whether the random number is within the random number interval allocated for the first page element set or the random number interval allocated for the second page element set,
if the random number is within the random number interval allocated for the first page element set, selecting the number of page elements with the determined attributes from the first page element set; and
if the random number is within the random number interval allocated for the second page element set, selecting the number of page elements with the determined attributes from the second page element set.

16. A method as recited in claim 15, wherein the random number interval allocated for the first page element set is directly proportional to a number of the first one or more page elements included in the first page element set, and the random number interval allocated for the second page element set is inversely proportional to a number of the second one or more page elements included in the second page element set.

17. A method as recited in claim 15, wherein the selecting the number of page elements with the determined attributes from the first page element set comprises:
selecting the number of page elements according to a descending order of weighted result values of one or more elements having the determined attributes in the first page element set.

18. A method as recited in claim 15, wherein the selecting the number of page elements with the determined attributes from the second page element set comprises:
selecting the number of page elements according to a descending order of a number of presentation times of one or more elements having the determined attributes in the second page element set.

19. A method as recited in claim 15, further comprising determining a respective weighted result value of a respective page element based on one or more types of operation information to the respective page element and respective weighted values of the one or more types of operation information.

20. An apparatus for determining page elements of a webpage, comprising:
a page element information determination unit that determines attributes of and a number of page elements to be presented at the webpage;
a page element determination unit that selects a number of page elements based on the determined attributes and their corresponding operation information from multiple page elements; and
a webpage determination unit that inserts the number of page elements at the webpage according to location information at the webpage corresponding to the determined attributes of the one or more page elements.
